(19) United States
(12) Patent Application Publication
(10) Pub. No.: US 2007/0234193 A1
(43) Pub. Date: Oct. 4, 2007

(54) Method for simultaneous display of multiple video tracks from multimedia content and playback system thereof

(76) Inventor: Huan-Hung Peng, Taipei County (TW)

Correspondence Address: NORTH AMERICA INTELLECTUAL PROPERTY CORPORATION, P.O. BOX 506, MERRIFIELD, VA, 22116, US

(21) Appl. No.: 11/277,760

(22) Filed: Mar. 29, 2006

(51) Int. Cl. G06F 17/00

(52) U.S. Cl. 715/500.1

(57) ABSTRACT

A method and system for simultaneously displaying multiple video tracks from multimedia content onto different display units is described. The method includes reading a video source signal from the multimedia content, and demultiplexing the video source signal into a plurality of video tracks. Each video track of the plurality of video tracks is decoded according to an encoding scheme of the multimedia content. Each video track of the plurality of video tracks is then rendered, with each video track from the plurality of video tracks outputted onto a different display unit from a plurality of display units.

### BACKGROUND OF THE INVENTION

1. Field of the Invention

The present invention relates to video playback, more specifically, a method and system for simultaneously displaying multiple video tracks on multiple display units from multimedia content.

2. Description of the Prior Art

With recent advancements in multimedia technology, the playback and viewing of multimedia releases have increasingly gained in popularity and enjoyment. Related storage mediums for multimedia data have also correspondingly increased in size to allow for more informational content to be enjoyed by the viewer. In the case of video content, such as DVDs, HDDVDs and BD titles, the increased storage usage is usually due to additional video tracks (which can consist of video angles), audio channels, and other additional features to enhance user enjoyment. Each of the different video tracks can consist of a unique camera angle or scene, and can normally be specifically selected by the user at the time of viewing. The different audio channels can comprise different languages, unique audio configurations, or subtitles, which again can be user selectable during playback.

FIG. 1 illustrates a typical video source signal 100 from multimedia content. The video source signal 100 is derived from reading the multimedia content with a related playback apparatus. The multimedia content can comprise of any storage medium such as a DVD disc, HDDVD disc, or even hard disc. As described above, multimedia content may contain several video tracks, which accompanies a main video track. When a multimedia video player reads multimedia content, it receives the video source signal 100, which comprises individual video tracks A₁ to Aₙ multiplexed into the single signal line. A user can then select one of the desired video tracks (A₁ to Aₙ) from the video source signal 100 so that it can be shown on a video display device for viewing.

As an example illustrating the different video tracks (or angles), assume that a panoramic nature video is produced showing a natural landscape. Due to the width of the landscape, and the limited field of vision of each camera, multiple cameras must be utilized to simultaneously capture the wide view of the landscape. In this case, various angles of the landscape are simultaneously recorded using a plurality of cameras. For example, if the landscape requires a 180-degree shot, and each camera is capable of only capturing a 30-degree angle, then six cameras would be needed to record the entire 180-degree panoramic shot. The recordings from each camera angle are then separated into the individual video tracks of the video source signal. In the editing process, the editor (or producer) determines the correspondence between the angles shot by the cameras and the choreography of scenes in the video title to complete the nature video.

FIG. 2 illustrates a typical method 200 used to view multimedia content according to the related art. The method 200 includes providing a multimedia disc 210, a multimedia playback device 220, and a display device 230. The multimedia playback device 220 reads a video source signal from the multimedia disc 210. When read by the multimedia playback device 220, the video source signal undergoes three main process steps. The first step is Navigation 222, which involves splitting and selecting one of the video tracks from the video source signal. Selection of the video track is usually determined through a default setting or by a user of the multimedia playback device 220. The selected video track is then decoded 224 according to the compression/encoding scheme utilized in the multimedia disc format for processing. Finally, the selected video track is rendered 226 to provide a proper video output for a corresponding display device 230.

Although multiple video tracks are typically available within the video source signal 100, only one related video track is selected through navigation 222 and outputted the multimedia player 220. Thus only a single video track can be viewed at a time through the related display device 230.

### SUMMARY OF THE INVENTION

One objective of the claimed invention is therefore to provide a method for simultaneously viewing multiple video tracks from multimedia content onto multiple display units to solve the above-mentioned problem.

According to an exemplary embodiment of the claimed invention, a method for simultaneously displaying multiple video tracks from multimedia content onto different display units is disclosed. The method comprises: reading a video source signal from the multimedia content and demultiplexing the video source signal into a plurality of video tracks. Each video track of the plurality of video tracks is decoded according to an encoding scheme of the multimedia content. Each video track of the plurality of video tracks is rendered and each video track from the plurality of video tracks is outputted onto a different display unit from a plurality of display units.

According to another exemplary embodiment of the claimed invention, a multimedia playback system is disclosed. The system comprises: a navigation unit for reading a video source signal from multimedia content and demultiplexing the video source signal into a plurality of video tracks, the multimedia content having multiple video tracks; a plurality of decoding units, each decoding unit for decoding a video track of the plurality of video tracks according to an encoding scheme of the multimedia content; and a plurality of rendering units, each rendering unit corresponding to one of the decoding units for simultaneously rendering each video track of the plurality of video tracks and for outputting each video track from the plurality of video tracks onto a different display unit from a plurality of display units.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 illustrates a video source signal according to the related art.

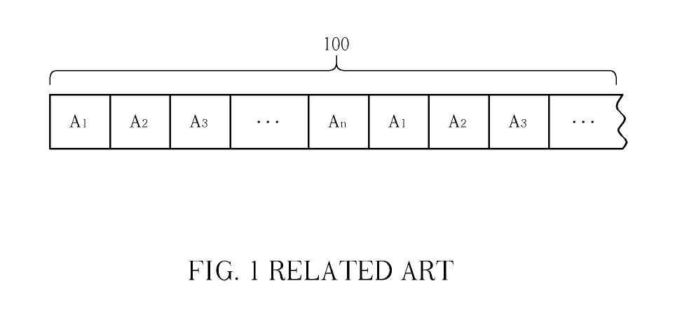

FIG. 2 illustrates a method to view a single video track from multimedia content according to the related art.

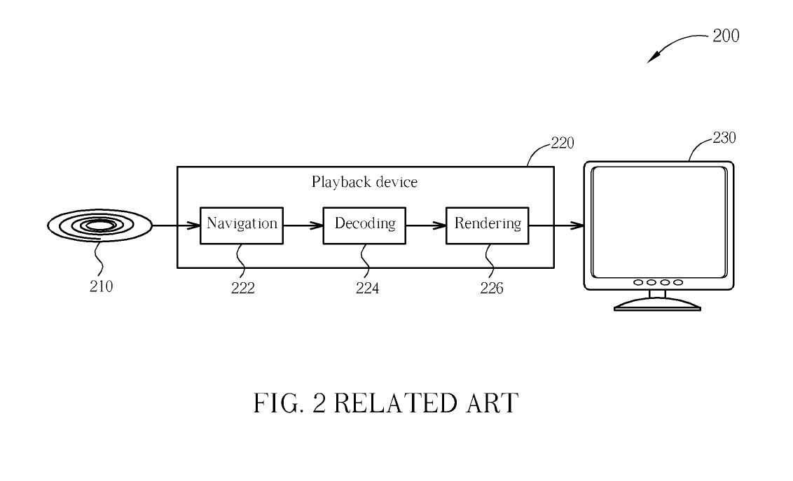

FIG. 3 illustrates a video playback system for simultaneous display of multiple video tracks from a multimedia content onto multiple display devices according to an exemplary embodiment of the present invention.

FIG. 4 shows a method for simultaneous display of multiple video tracks from multimedia content according to an exemplary embodiment of the present invention.

### DETAILED DESCRIPTION

Current related art methods do not allow multiple video tracks from multimedia content to be displayed simultaneously onto different display devices. Thus when watching the nature video described above, a user can only enjoy the landscape from a certain camera angle, even though multiple camera angles may be included within the multimedia content. The user cannot simultaneously view the multiple camera angles onto different display devices to achieve a full 180-degree field. The video track may be set to a default track as determined through editing by a producer, or can be selected by the user. In any case, the user is generally limited to solely to watching one specific camera angle at a time on a single display device. Conversely, if the producer of the video wants to create a wide-angle panoramic effect for a viewer of their title, they cannot simultaneously show multiple angles of the landscape onto different display devices, as current methods do not support this option.

The present invention therefore provides a method for simultaneously viewing multiple video tracks of multimedia content onto multiple display devices to solve the above-mentioned problem. Each display device shows a specific video track, which can correspond to a unique camera angle from the same multimedia content.

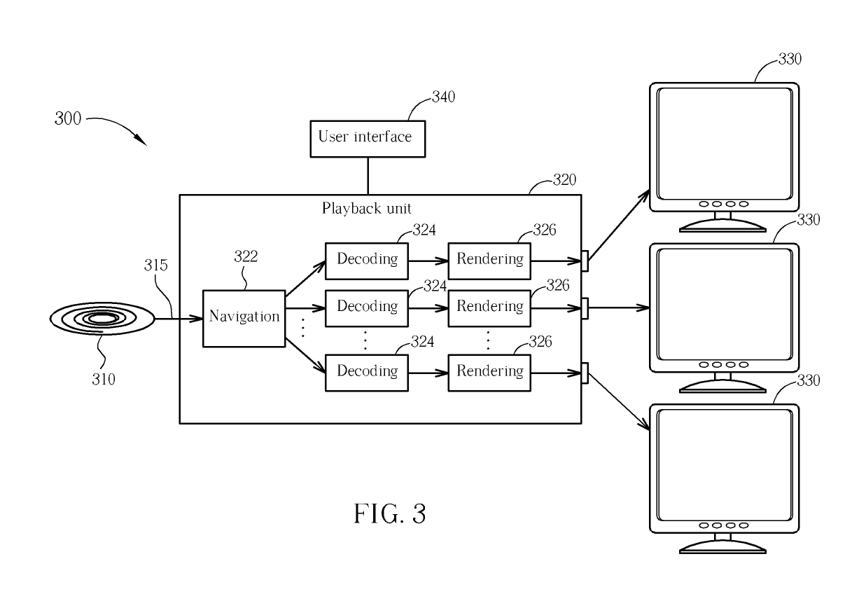

FIG. 3 illustrates a multimedia playback system 300 for simultaneously displaying multiple video tracks from multimedia content onto multiple display devices according to an exemplary embodiment of the present invention. The system 300 includes multimedia content 310, a multimedia playback unit 320, and a plurality of display devices 330 coupled to the multimedia playback unit 320.

The multimedia content 310 can comprise an optical disc (DVD, VCD, BD, HDDVD), a hard disc format storage unit or a solid state memory device. The multimedia content 310 further comprises multimedia data containing a plurality of video tracks. The video tracks can correspond to different camera angles of a multimedia presentation, or to different camera shots altogether as arbitrarily defined by the producer of the multimedia content 310. The multimedia data forms the video source signal 315, which is read by the multimedia playback unit 320. The video source signal 315, can also represent a satellite TV, digital TV (DTV) signal or a high-definition TV (HDTV) signal, while the multimedia content 310 is the programming sent from the signal provider.

Upon reading the video source signal 315 of the multimedia content 310, the multimedia playback unit 320 undergoes a series of process steps before providing multiple track outputs to the display devices 330. These process steps may be performed by the individual components as listed below. The first part is conducted in Navigation 322, where the video source signal 315 is demultiplexed (or split) into different separate video tracks. Again, each video track generally corresponds to a specific camera angle or view of a screen shot, but can also correspond to arbitrary video footage as defined by a producer of the multimedia content 310. Upon demultiplexing the video source signal 315, each individual video track is individually decoded 324. FIG. 3 illustrates a plurality of decoding blocks 324 signifying the decoding of each separate video track according to the available number of video tracks. Upon decoding each video track, they are subjected to rendering 326 to prepare each video track for output to a display device 330. FIG. 3 again illustrates a plurality of rendering blocks 324 signifying the rendering process performed on each separate video track according to the available number of video tracks. Once rendering is completed, each processed video track is outputted from the multimedia playback unit 320 to a separate display unit 330. Each video track remains isolated and separate from other video tracks, and is displayed onto different display units 330. Therefore, no two display units show the same video track.

The multimedia playback unit 320 can more specifically implemented as a DVD player, an optical disc player, a computer, or a graphics device card, and is not limited to a single device type. Regardless of the specific apparatus type of the multimedia playback unit 320, it should possess multiple video outputs and be able to perform the above mentioned process steps in order to simultaneously display each video track onto separate display devices. The display device can comprise a television, a projector, an LCD display, or a computer monitor, amongst other possibilities.

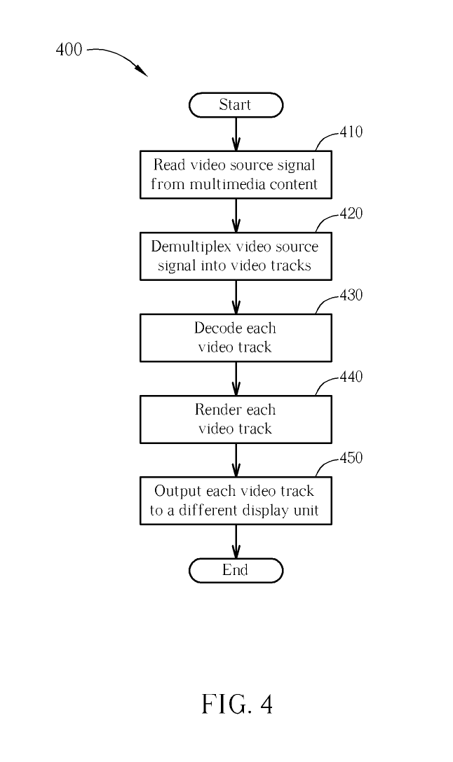

FIG. 4 illustrates a method for simultaneous display of multiple video tracks from multimedia content according to an exemplary embodiment of the present invention. This is detailed through the process steps listed below. Provided that substantially the same result is achieved, the steps of the process 400 need not be in the exact order shown and need not be contiguous, that is, other steps can be intermediate. In this embodiment, simultaneous display of multiple video tracks from multimedia content includes the following steps:

Step 410: Read a video source signal from the multimedia content.

Step 420: Demultiplex the video source signal into a plurality of video tracks.

Step 430: Decode each video track of the plurality of video tracks according to the encoding scheme of the multimedia content.

Step 440: Render each video track of the plurality of video tracks.

Step 450: Output each video track of the plurality of video tracks to a different display unit.

A user interface 340 can be further coupled to the multimedia playback unit 320 for a viewer to input desired playback settings. For example, a user can specify the specific video tracks to be sent to the video displays 330 through the user interface 340. The user interface 340 comprises the proper input and output terminals to communicate relevant viewing options to the user.

The present invention therefore provides a method to solve the need for simultaneously displaying multiple tracks from multimedia content onto different display devices. This will allow a viewer of the multimedia content to have an option of viewing multiple, or even all of the included video tracks of the multimedia content at the same time to enhance viewing pleasure. This will also allow for an exceptional display of panoramic or wide-angle footage, as displays can be configured surrounding a viewer of the program, with each display showing a specific angle of the footage. Furthermore, a user can select the desired video tracks to be viewed according to the available video tracks in the multimedia content.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method for simultaneously displaying multiple video tracks of multimedia content onto different display units, the method comprising:
reading a video source signal from the multimedia content;
demultiplexing the video source signal into a plurality of video tracks;
decoding each video track of the plurality of video tracks according to an encoding scheme of the multimedia content;
rendering each video track of the plurality of video tracks;
outputting each video track from the plurality of video tracks simultaneously onto a different display unit from the plurality of display units.

2. The method of claim 1 wherein the multimedia content is a DVD disc, an HDDVD disc, or a BC disc.

3. The method of claim 1 wherein the multimedia content is an optical disc.

4. The method of claim 1 wherein the multimedia content is a solid state memory device.

5. The method of claim 1 wherein the video source signal is a DTV satellite signal or an HDTV signal.

6. The method of claim 1 further comprising providing a user interface, the user interface for allowing a viewer of the multimedia content to select the video tracks of the plurality of video tracks to be outputted to the different display devices.

7. The method of claim 1, wherein no two display units display the same video track.

8. A playback system for simultaneously displaying multiple video tracks from multimedia content onto different display units, the system comprising:
a navigation unit for reading a video source signal from multimedia content and demultiplexing the video source signal into a plurality of video tracks;
a plurality of decoding units, each decoding unit for decoding a video track of the plurality of video tracks according to an encoding scheme of the multimedia content;
a plurality of rendering units, each rendering unit corresponding to one of the decoding units for simultaneously rendering each video track of the plurality of video tracks and for outputting each video track from the plurality of video tracks onto a different display unit from a plurality of display units.

9. The playback system of claim 8, wherein the multimedia content is a DVD disc, an HDDVD disc, or a BC disc.

10. The playback system of claim 8, wherein the multimedia content is an optical disc.

11. The playback system of claim 8, wherein the multimedia content is a solid state memory device.

12. The multimedia playback device of claim 8, wherein the video source signal is a DTV satellite signal or a HDTV signal.

13. The multimedia playback device of claim 8 further comprising a user interface for allowing a viewer of the multimedia content to select the video tracks of the plurality of video tracks to be outputted to the different display devices.

14. The multimedia playback device of claim 8, wherein no two display units display the same video track.

15. The playback system of claim 8, wherein the multimedia content possesses multiple video tracks.
